(19) United States
(12) Patent Application Publication
(10) Pub. No.: US 2019/0009125 A1
(43) Pub. Date: Jan. 10, 2019

(54) Removable sliding unit

(71) Applicant: William Daiei Matsuda, Issaquah, WA (US)

(72) Inventor: William Daiei Matsuda, Issaquah, WA (US)

(73) Assignee: William Daiei Matsuda, Issaquah, WA (US)

(21) Appl. No.: 15/645,942

(22) Filed: Jul. 10, 2017

(51) Int. Cl. A63B 21/072; F16B 7/04; A63B 21/075; A63B 21/00

(52) U.S. Cl. CPC A63B 21/0728; F16B 7/0406; A63B 21/4035; A63B 21/075; A63B 21/0724

(57) ABSTRACT

The present invention generally relates to improvements in exercise equipment that utilize sliding grips that are not easily removeable and require proprietary bars. The present invention discloses a removable sliding unit comprising of outer collars (2), resistive members (3), and removable sliding grips (4). When used in conjunction with Olympic standard bench bars, theoretical exercise movements as shown in FIG. 5, FIG. 6, and but not limited to FIG. 7 are possible.

### BACKGROUND OF THE INVENTION

### Field of the Invention

The present invention generally relates to workout accessories to improve the users range of motion, reduce joint pain, and allow for resistance training.

### Description of the Related Art

There exists a workout equipment known as IsoBar, it comprises of a proprietary Olympic style free weight bar and non removeable sliding grips. This device when properly used, improves the range of motion, enhances targeting of specific muscle groups, and decreases joint stress during associated exercise movements. However, because this workout equipment is a single integrated unit comprising of a proprietary bar, and sliding grips, the sliding grips are not easily removeable and unable to attach easily to other bars or pipes.

The U.S. Pat. No. 7,086,999 allows the user to exercise with sliding grips that are equidistant away from each other with the use of pulleys on each end of the bar, and prevents rotation of the grip by having slots on the bar. However, the said invention requires the use of a proprietary bar and a pulley system.

The U.S. Pat. No. 5,152,731 allows the user to exercise with sliding grips. The said invention comprises of grips with bearings, and stoppers to prevent overtravel of the grips, however, this invention requires a proprietary bar, and stoppers. The invention also has no way to control the resistance of the grips sliding.

The patent 20120094812 allows the user to perform push up like exercises with the means of a sliding grip and resistive bands to control the resistance of the sliding grip, however the invention requires a proprietary bar.

The prior art examples indicate that the prior inventions require a proprietary bar and sliding grips that are not easily removeable.

### SUMMARY OF THE INVENTION

The present invention is to provide an exercise unit that can be used in various exercises to improve the users range of motion, add resistive training, enhance targeting of specific muscle groups, and decrease joint stress. The present invention allows to be installed and removed without the need of a proprietary bar exclusive to this invention.

According to the present invention, it is comprising of a removable sliding grip, outer collar, and resistive members.

The removable sliding grip is characterized in that of rolling elements, hinges, closing mechanism, grip section, and attachment points. The rolling elements allow the removable sliding grip to slide above a bar that is not proprietary to this unit, for example but not limited to Olympic standard bench bars. The hinges allow for a pivot point for the removable sliding grip to open and close. The closing mechanism allows the removable sliding grip to open or close for easy install or removal. The grip section allows the user to grasp the removable sliding grip during their exercise. The attachment point allows for attachment of resistive members or aftermarket accessories. The removable sliding grip eliminates the need for a proprietary bar as compared to any prior art.

The outer collar is characterized in that of a sleeve, and an attachment point. The sleeve allows the outer collar to slide onto a bar that is not proprietary to this unit, for example but not limited to the outer ends of an Olympic standard bench bar. The outer collar when used with a resistive member connected to the attachment point, serves to control the range of movement the removable sliding grip can travel, and allow for exercises with aftermarket products to serve as a mounting point when used in conjunction with exercise bands.

The resistive member controls the resistance and range of motion of the removable sliding grip, the resistive member also allows the user to perform various exercises when the resistive member is used in conjunction with the outer collar or the removable sliding grip.

### BRIEF DESCRIPTION OF DRAWINGS

FIG. 1: Theoretical use of the Invention attached to an Olympic standard bench bar.

FIG. 2: Multiple views of the removable sliding grip.

FIG. 3: Exploded view of the removable sliding grip.

FIG. 4: Multiple views of the outer collar.

FIG. 5: Invention attached and in use during bench press exercises.

FIG. 6: Outer collar and resistive member attached to a Smith Machine for resistance exercises.

FIG. 7: Invention attached to an Olympic standard bench press bar inserted in a weighted holder for resistance exercises.

### DETAILED DESCRIPTING OF THE INVENTION

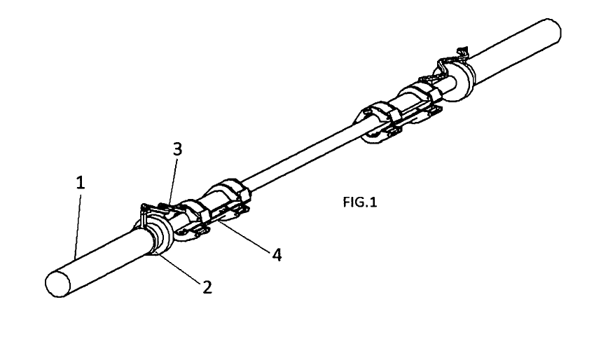

FIG. 1 is a representation of the Invention when attached to an Olympic standard bench bar 1. The Outer collar 2 is slid on the ends of the Olympic standard bench bar 1, the removable sliding grip 4 is attached to the gripping section of the Olympic standard bar 1, and the resistive member 3 is attached to both the outer collar 2 and the removable sliding grip 4. When attached in this manner, the user can perform bench press like exercises with grips that slide to improve the range of motion, enhance targeting of specific muscle groups, and decreases joint stress during the users associated exercise movements.

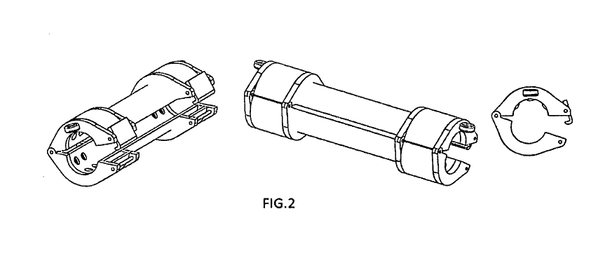

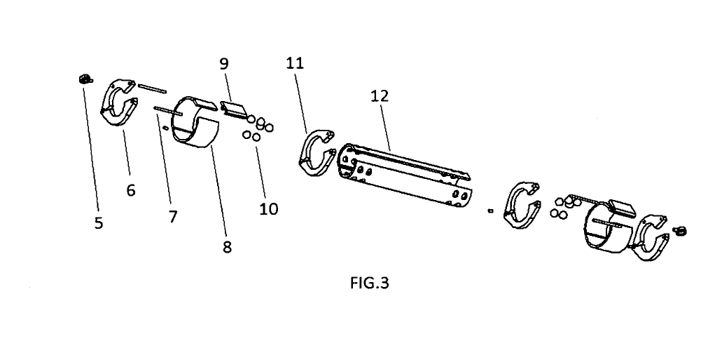

FIG. 2 shows the Multiple views of the removeable sliding grip. The removable sliding grip comprises of attachment points 5, outer cuff 6, pins 7, rolling element cover 8, closing mechanism 9, rolling elements 10, inner cuff 11, and a gripping section 12 as depicted in FIG. 3.

The attachment point 5, serves to allow the resistive member 3 to be secured onto the removable sliding grip FIG. 2. This attachment point 5 can is characterized in that an eye bolt for example or a hole machined into the outer cuff 6.

The outer cuff 6 and the inner cuff 7 can be machined with holes that allow for pins 7 to be inserted, machined with holes to attach the closing mechanism 9, and machined to attach the attachment point 5. The outer and inner cuff 6,11 can be attached to the gripping section 12 by means of welding or screws.

The pins 7 can be machined to the diameter of the holes machined on the outer cuff 6 and inner cuff 11.

The rolling element cover 8, can be machined to allow the rolling elements 10 to slide on its inner surface, and secure the rolling elements 10 from falling out. The rolling element cover 8 can be attached to the outer and inner cuffs 6,11 be means of welding or screws.

The closing mechanism 9 can be machined to enable the removeable sliding grip FIG. 2 to open and close.

The rolling elements 10 can be machined to allow the rolling elements 10 to freely slide over a bar for example the Olympic standard bar 1.

The gripping section 12 can be machined to allow the rolling elements 10 to freely slide over a bar for example the Olympic standard bar 1, allow the user to grip the removeable sliding grip FIG. 2, and serve as an component where the outer and inner cuffs 6,11 can be attached.

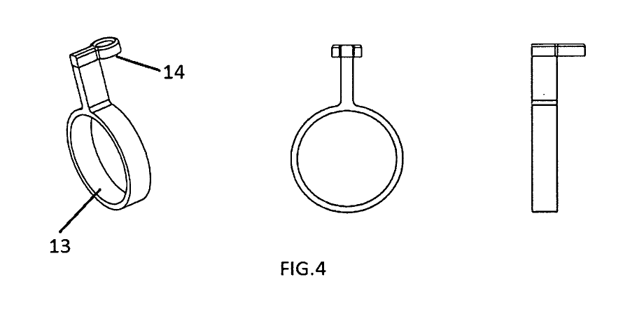

The outer collar FIG. 4 can be machined to allow the inner ring 13 to slid into, for example the ends of the Olympic standard bench bar 1. The attachment points 14 can be a threaded eye bolt that it threaded onto or welded onto the body of the outer collar FIG. 4 or machined and attached to the body of the outer collar 11.

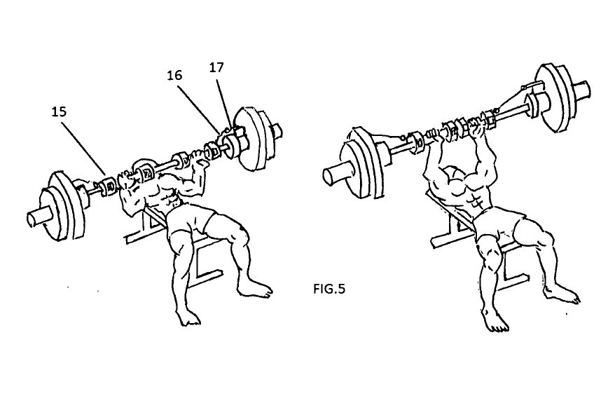

A theoretical use of this invention is shown by FIG. 5. It shows the present invention in use with the removeable sliding grip 15, resistive member 16, and outer collar 17. When used in this fashion, the user can perform bench press like exercises with removable sliding grips 15, that slide to improve the range of motion, enhance targeting of specific muscle groups, and decreases joint stress during the users associated exercise movements. The Resistive member 16 controls the amount of resistance on the removeable sliding grip 15. Finally, the outer collar 17 serves as an attachment point for the resistive member 3.

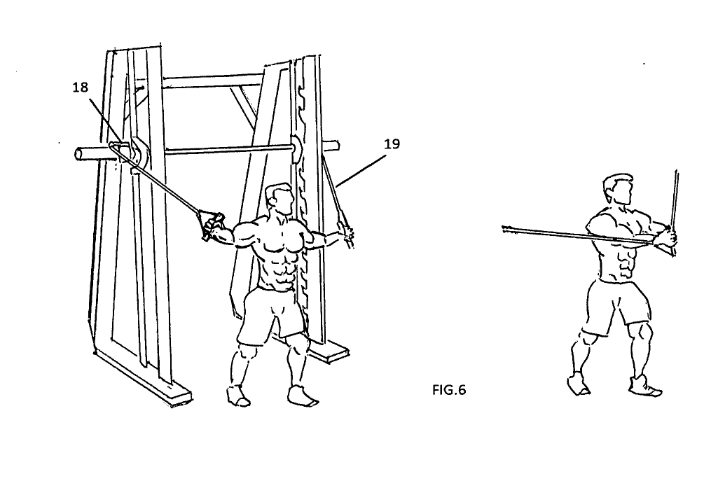

Another theoretical use of this invention is shown by FIG. 6. It shows the outer collar 18 slid onto the ends of a smith machine with the bar having similar dimensions as that of an Olympic standard bar 1, and a resistive member 19 in the form of a long rubber tube. The user can perform resistance training exercises with the outer collar FIG. 4 being an attachment point for the resistive member 3.

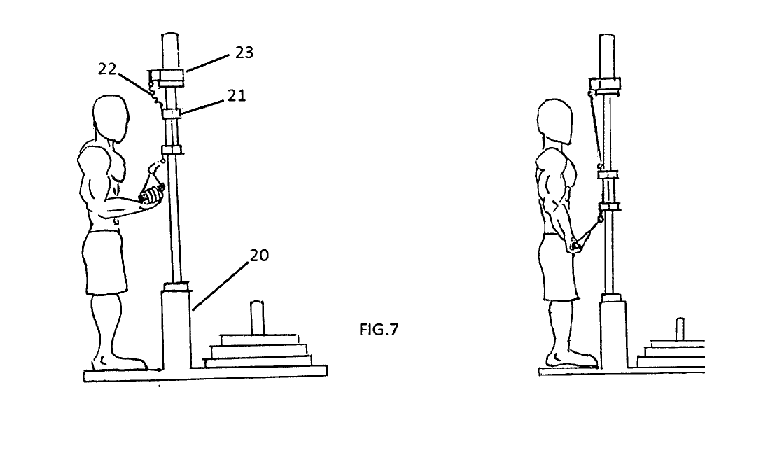

When linear movements are sought after, another theoretical use of this invention is shown by FIG. 7, where the outer collar 23 is slid onto the one end of the Olympic standards bench bar 1, resistive member 22 attached onto the outer collar 23, and the removable sliding grip 21, and finally the Olympic standard bench bar 1 being held by an Olympic standard bench bar holder 20. When used in this fashion the user can grip the removable sliding grip 21 and pull down for resistance training, or attach aftermarket accessories onto the removeable sliding grip 21 for additional variance in gripping styles.

1. A Removable sliding unit comprising of:
outer collars (2) to attach resistive members and aftermarket accessories;
resistive members (3) that allows for resistance training, and limit the travel of the removable sliding grips (4);
removable sliding grips (4) that can be attached to bars and pipes, not proprietary to this invention.

2. A Removable sliding grip comprising of:
attachment points (5) for resistive members, and aftermarket accessories;
outer cuffs (6) that can serve as a body to attach attachment points (5), rolling element covers (8), pins (7), and closing mechanisms (9);
a rolling element covers (8) to secure the rolling elements (11).
pins (7) to hold together the inner and outer cuffs (6,11);
closing mechanisms (9) to install and remove the removable sliding grip (4) from nonproprietary bars;
rolling elements (11) to allow the removable sliding grip to freely slide over nonproprietary bars;
gripping sections (12) to allow the user to grip the removable sliding grip (4).
